(19) United States
(12) Patent Application Publication
(10) Pub. No.: US 2007/0059174 A1
(43) Pub. Date: Mar. 15, 2007

(54) Windmill with rotating panes

(76) Inventor: David Girard, Mc Watters (CA)

Correspondence Address: INVENTARIUM, Suite 1607, 4050 Rosemont Blvd, Montreal, QC, H1X 1M4, CA

(21) Appl. No.: 11/522,187

(22) Filed: Sep. 14, 2006

Related U.S. Application Data
(60) Provisional application No. 60/716,604, filed on Sep. 14, 2005.

(51) Int. Cl. B64C 27/54

(52) U.S. Cl. 416/98

(57) ABSTRACT

A windmill comprises means for orienting panes so that each panes shows optimal surface area windside. A plurality of supporting frames to hold the panes around a central axis, drive means for communicating between each panes' rotational axis and the central axis, an orientation means to reorient the panes according to wind direction.

This application claims priority based on provisional application 60/716,604 filed Sep. 14, 2005

### BACKGROUND OF THE INVENTION

1. Field of the Invention

The invention relates generally to windmills but more particularly to a simple to build and maintain windmill.

2. Background of the Invention

The windmill art comprises thousands of variations of different windmill configurations. Since windmills are often seen as a solution to the woes afflicting developing countries, it is important to make sure that the windmill can be built, serviced and repaired using locally available components - something that many overly complicated windmill designs fail to accomplish.

In the late nineteenth century, U.S. Pat. No. 232,205 by Preston showed a simple system using a plurality of panes revolving around a drum. Each pane is allowed to move so as to present a suitable surface for the wind to pick up. The panes are hung on one side much like a door is hung on one side on its hinges.

More recently, U.S. Pat. Nos. 4,115,027 and 6,688,842 have used the moving panes model but U.S. Pat. No. 4,115,027 only appears to have rotating panes, they are only airfoils directing wind to the windmill located at its center and the panes can only be slightly oriented so as to better orient the wind according to wind speed.

U.S. Pat. No. 6,688,842 has a complex system of airfoils with leading and trailing edges that are limited in their range of motion so as to create a series of complex airfoil arrangements according to various factors such as wind speed and direction.

### SUMMARY OF THE INVENTION

It is a main advantage of this invention to provide for a windmill that is simple to build using easily available materials.

It is another advantage of this invention to provide for a windmill that is easy to service.

It is a final advantage of this invention to provide for a windmill that is easy to repair.

In order to do so, the invention comprises means for orienting panes so that each panes shows optimal surface area windside. A plurality of supporting frames to hold the panes around a central axis, drive means for communicating between each panes' rotational axis and the central axis, an orientation means to reorient the panes according to wind direction.

The plurality of supporting frames is located one at each end of each pane so that each pane is rotationally attached to a pair of said supporting frame.

Each supporting frame extends radially from the central axis around which each supporting frame rotates.

In one embodiment, a wind vane is used as orientation means.

In another embodiment, the drive means is in the guise of gears and chains.

In another embodiment, the drive means communicates between each pane's rotational axis, and each pane's rotational axis having its pane rotational axis' gear and a central axis gear.

The windmill has the following method of operation:

The central axis gear is directly connected to the orientation means so that the orientation means can rotate the central axis gear so as to reorient the panes by way of the drive means so that each pane presents its optimal orientation so that the wind can initiate motion of the supporting frame onto which the pane is being rotationally attached and the supporting frame is rotationally attached to the central axis.

The materials used for building the windmill are materials such as wood, canvas, rope or aluminum, steel and plastics if they are readily available. As such, construction can be adapted to various budgets and available resources.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE PREFERRED EMBODIMENT

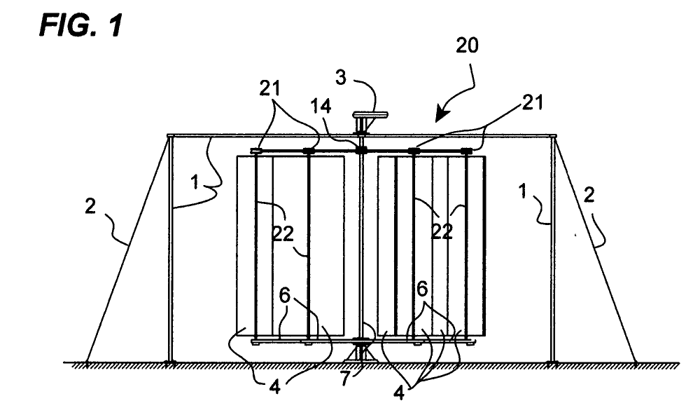

FIG. 1 Side view of vertical axis model.

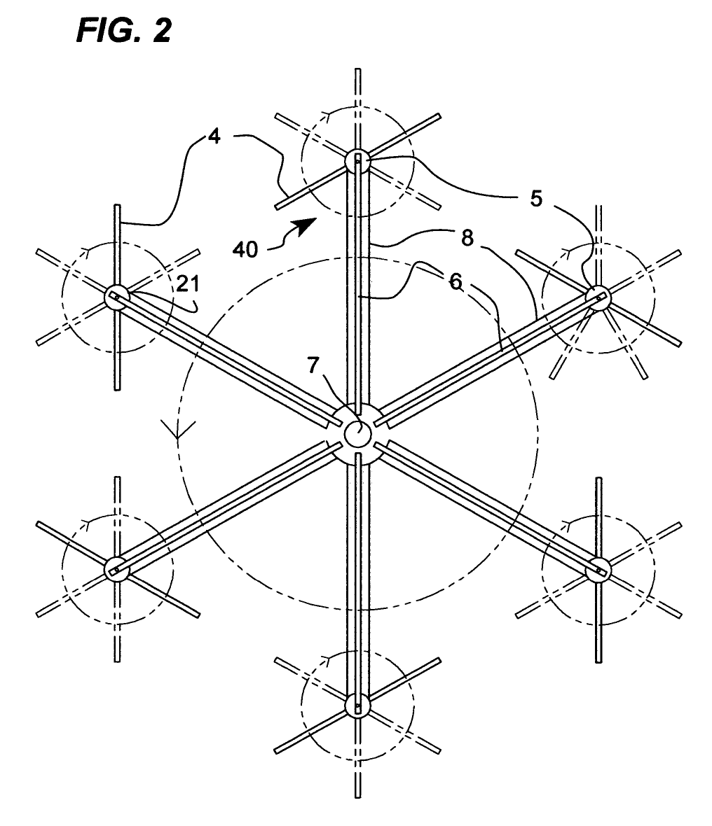

FIG. 2 Plan view of vertical axis model.

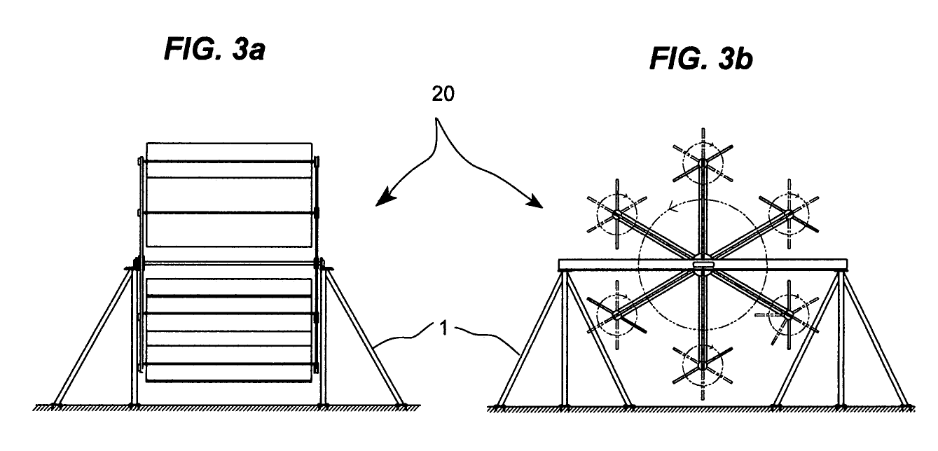

FIG. 3ab Side and plan views, respectively, of horizontal axis model.

### DETAILED DESCRIPTION OF THE PREFERRED EMBODIMENT

A windmill (20) has a support frame (1) with cables (2) tensioned between them and the ground. A wind vane (3), is used as an orientation means (30) to reorient the panes (4) according to wind direction so that each pane (4) shows its most optimal side to the wind for increased efficiency. That is, not only the largest surface but also the surface onto which the wind can best apply pressure without causing too much turbulence.

There are a plurality of supporting frames (6), one at each end of each pane (4) so that each pane (4) is rotationally attached to a pair of supporting frames (6). Each supporting frame (6) extends radially from a central axis (7) around which it rotates. Drive means (40)—which can come in the guise of gears (5), and chains (8), or mechanical equivalents thereof—communicate between each pane's rotational axis (22), with each pane's rotational axis (22) having its pane rotational axis' gear (21) connecting to the central axis gear (14).

This central axis gear (14) is directly connected to the wind vane (3) so that the wind vane (3) can rotate the central axis gear (14) so as to reorient the panes (4) by way of the drive means (40) so that, depending upon the direction the wind is coming from, each pane (4) will be rotated so as to present the optimal orientation for the wind to initiate motion of the windmill (20). The central axis gear (14) rotates independently from the central axis (7). The pane's rotational axis (22) is located halfway along the width of the pane (4) so that the pane (4) rotates symmetrically around the pane'S rotational axis (22) as opposed to asymmetrically as per U.S. Pat. No. 232,205 for example.

Each pane (4) respects a given positional relationship with adjacent panes (4) so that as long as one given pane (4) is oriented optimally by the wind vane (3) (or any equivalent thereof as will be further described later), the other panes (4) are also oriented since they are all simultaneously driven by the same drive means (40). That relational positioning of the panes (4) is set during initial assembly. It is obvious that if the wind is to exert the same amount of pressure on the right hand side of the central axis (7) as it is to the left hand side, the windmill (20) will not rotate, that is why the panes (4) on one side of the axis have to show a far less optimal surface so as to offer the least wind resistance and allow for rotation. It is that positional relationship that has to be set during initial assembly of the windmill (20) so that no matter the wind direction, the panes (4) always reorient themselves.

Communicating the wind's energy captured by the panes (4) towards the central axis (7) is what makes the windmill (20) useful. Of course, this is done by the fact that each pane (4) applies force to the supporting frame (6) onto which it is rotationally attached so as to induce rotation, and the supporting frames (6), being rotationally attached to the central axis (7), transfer that rotational motion to an electric generator or mechanical means such as a pump as is well known in the art.

Alternatively, an electronic component embedded in a central gear box (not shown), which itself acts as mechanical equivalent to the central axis gear (14), can replace the wind vane (3) with sensors (not shown) to detect the wind direction and provide the proper orientation by way of an electric motor (not shown) actuating the drive means assembly (40).

Another alternative is to replace the chains (8) and gears (5) by drive shafts (not shown) connecting to gear boxes (not shown). In both cases the parts act as drive means assembly (40) between the panes (4) and the central axis (7). The windmill (20) can also work if the central axis (7) is set horizontally, as per FIG. 3ab, instead of vertically, as per FIG. 1.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A windmill comprising:
means for orienting panes so that each said panes shows optimal surface area windside;
a plurality of supporting frames to hold said panes around a central axis;
drive means for communicating between each said panes' rotational axis and said central axis;
an orientation means to reorient said panes according to wind direction.

2. A windmill as in claim 1 wherein:
said plurality of supporting frames is located one at each end of each said pane so that each said pane is rotationally attached to a pair of said supporting frame.

3. A windmill as in claim 1 wherein:
each said supporting frame extends radially from said central axis around which each said supporting frame rotates.

4. A windmill as in claim 1 wherein:
a wind vane is used as orientation means.

5. A windmill as in claim 1 wherein:
said drive means is in the guise of gears and chains.

6. A windmill as in claim 1 wherein:
said drive means communicating between each pane's rotational axis, and with each pane's rotational axis having its pane rotational axis' gear connecting to said central axis gear.

7. A windmill as in claim 1 having the following method of operation:
said central axis gear is directly connected to said orientation means so that said orientation means can rotate said central axis gear so as to reorient said panes by way of said drive means so that each said pane presents its optimal orientation so that the wind can initiate motion of said supporting frame onto which said pane is being rotationally attached and said supporting frame being rotationally attached to said central axis.

8. A windmill as in claim 1 wherein:
said means for communicating between each said panes' rotational axis and said central axis being in the form of gears, and chains set between each said pane's rotational axis and a gear located on said central axis;

9. A windmill as in claim 1 wherein:
said central axis gear being directly connected to a wind vane acting as said means for rotating said central axis so as to reorient said panes.

10. A windmill as in claim 1 wherein:
said central axis gear being directly connected to an electronic component embedded in a central gear box acting as said means for rotating said central axis so as to reorient said panes by using sensors to detect wind direction and provide orientation to said panes by way of an electric motor.

11. A windmill as in claim 1 wherein:
said means for communicating between each said panes' rotational axis and said central axis being in the form of drive shafts set between each said pane's rotational axis and a gear box located on said central axis.

12. A windmill as in claim 1 wherein:
said pane's rotational axis located halfway along width of said pane so that said pane rotates symmetrically around said pane's rotational axis.
